(19) United States
(12) Patent Application Publication
(10) Pub. No.: US 2024/0296859 A1
(43) Pub. Date: Sep. 5, 2024

(54) METHOD FOR ANALYSING A NOISY SOUND SIGNAL FOR THE RECOGNITION OF CONTROL KEYWORDS AND OF A SPEAKER OF THE ANALYSED NOISY SOUND SIGNAL

(71) Applicants: CENTRE NATIONAL DE LA RECHERCHE SCIENTIFIQUE, PARIS (FR); UNIVERSITÉ DE MONTPELLIER, MONTPELLIER (FR)

(72) Inventors: Bijan MOHAMMADI, MONTPELLIER (FR); Jean-Michel LINOTTE, VILLEPREUX (FR)

(21) Appl. No.: 18/697,907

(22) PCT Filed: Oct. 3, 2022
(86) PCT No.: PCT/EP2022/077461

§ 371 Date: May 2, 2024

(30) Foreign Application Priority Data
Oct. 5, 2021 (FR) 2110510

(51) Int. Cl. G10L 25/84; G10L 15/06

(52) U.S. Cl. CPC G10L 25/84; G10L 15/063

(57) ABSTRACT

A method for analysing a noisy sound signal for the recognition of at least one group of control keywords and of a speaker of the analysed noisy sound signal, the noisy sound signal being recorded by a microphone and the method including: supervised training of an artificial neural network using a training database in order to obtain a trained artificial neural network capable of providing, based on a sound signature obtained from a noisy sound signal, a prediction of the speaker and at least one prediction of a group of control keywords, the training database including a plurality of sound signatures, each associated with a speaker and with at least one group of control keywords; calculating a sound signature of the analysed noisy sound signal; using the trained artificial neural network on the calculated sound signature in order to obtain a prediction of the speaker and at least one prediction of a group of control keywords.

### TECHNICAL FIELD OF THE INVENTION

The technical field of the invention is that of the analysis of sound signals and in particular the analysis of noisy sound signals for the recognition of command keywords and their speaker.

The present invention relates to a method for analysing a noisy sound signal and in particular to a method for analysing a noisy sound signal for the recognition of at least one group of command keywords and a speaker of the noisy sound signal. The present invention also relates to a system for implementing the method according to the invention.

### TECHNOLOGICAL BACKGROUND OF THE INVENTION

With the explosion in the number of home automation objects in households, the need has arisen for a centralised control enabling each home automation object to be remotely controlled.

To meet this need, communication gateways and more particularly connected loudspeakers have been developed. These communication gateways also exist in the industrial sector for other types of equipment, such as robots, machine tools or controlled gates.

These connected loudspeakers are capable of analysing sound signals to identify and recognise predefined command keywords present in the sound signal analysed and send the corresponding commands via a wireless link to the home automation objects concerned. The identification and recognition of the command keywords is generally carried out as soon as a particular keyword, known as the activation keyword, has been detected in order to avoid triggering commands unintentionally.

These loudspeakers use an on-line machine learning algorithm, which has been trained in a supervised manner on a training database stored on a cloud. The training database includes a multitude of sound signals, each associated with the activation keyword and the command keywords present in the sound signal. At the end of the training, the algorithm is capable of detecting the activation keyword and recognising each command keyword present in a sound signal that the algorithm has encountered during its training.

However, the connected loudspeaker is not always able to recognise the command keywords present in a sound signal, particularly when the speaker has a particular accent or uses a language not represented in the training database.

There is therefore a need for an algorithm for analysing sound signals to recognise command keywords, regardless of the speaker's linguistic specificities.

### SUMMARY OF THE INVENTION

The invention provides a solution to the previously discussed problems, by making it possible to recognise each command keyword present in a sound signal regardless of the linguistic specificities of its speaker.

A first aspect of the invention relates to a method for analysing a noisy sound signal for the recognition of at least one group of command keywords and a speaker of the noisy sound signal analysed, the noisy sound signal to be analysed being recorded by at least one microphone and the method comprising the following steps of:
Constituting a training database comprising the following sub-steps of:
   For each speaker to be recognised, recording at least one noiseless sound signal spoken by the speaker;
   Recording, by the microphone, the environmental noise, the environmental noise being a noise generated by the speaker's sound environment;
   For each noiseless sound signal recorded, adding the noise recorded to the noiseless sound signal to obtain a noisy sound signal;
   For each noisy sound signal obtained, calculating a sound signature of the noisy sound signal obtained;
   For each sound signature calculated, associating the sound signature calculated with the speaker who spoke the corresponding noiseless sound signal and with at least one group of command keywords;
Supervised training of an artificial neural network on the training database to obtain an artificial neural network trained capable of providing, from a sound signature obtained from a noisy sound signal, a prediction of speaker and at least one prediction of command keyword group;
Calculating a sound signature of the noisy sound signal analysed;
Using the artificial neural network trained on the sound signature calculated to obtain a prediction of speaker and at least one prediction of command keyword group.

By means of the invention, the artificial neural network is trained to be capable both of recognising each command keyword present in the sound signal analysed and identifying the speaker of the sound signal analysed.

As the speaker of the sound signal is identified, it is possible to authorise triggering of commands corresponding to the command keywords recognised only when the identified speaker belongs to a group of approved speakers.

Training is carried out on a training database comprising, for each speaker to be recognised, a plurality of sound signatures obtained from noiseless sound signals recorded by the speaker himself, thus having the specificities of the speaker such as his language or accent, and the command keywords that the speaker wishes to use. Recognition of the speaker by the artificial neural network is therefore facilitated without the need for a phoneme-translation step or a language comprehension step, and each speaker can personalise the command keywords used.

In addition, the training database takes account of the noise in the proximity of the microphone, which improves performance of the artificial neural network on sound signals recorded by the microphone with similar noise.

Furthermore, training is carried out on a single training database enabling, on the one hand, learning of command keywords by the artificial neural network and, on the other hand, the identification of biometric characteristics enabling the speaker to be recognised by the artificial neural network. The amount of data required for the artificial neural network to learn is therefore much less than that required in the state of the art, where these two tasks are carried out separately on two distinct training databases.

In addition to the characteristics just discussed in the preceding paragraph, the method according to the first aspect of the invention may have one or more complementary characteristics from among the following, considered individually or according to any technically possible combinations.

According to an alternative embodiment, the artificial neural network trained is further capable of providing, from a sound signature, a prediction of activation binary relating to the detection or non-detection of at least one group of activation keywords, each sound signature of the training database being further associated with an activation binary, the step of using the artificial neural network trained making it possible to further obtain a prediction of activation binary.

According to an alternative embodiment compatible with the preceding alternative embodiment, the artificial neural network trained is further capable of providing, from a sound signature, a prediction of termination binary relating to the detection or non-detection of at least one group of termination keywords, each sound signature of the training database being further associated with a termination binary, the step of using the artificial neural network trained making it possible to further obtain a prediction of termination binary.

Thus, the performance of the artificial neural network for the recognition of command keywords is increased since the range of the sound signal analysed comprising command keywords is delimited by the group of activation keywords on the one hand and the group of termination keywords on the other hand.

According to an alternative embodiment compatible with the preceding alternative embodiments, the artificial neural network trained is further capable of providing, from a sound signature, at least one prediction of link binary relating to the detection or non-detection of at least one group of link keywords, each sound signature of the training database being further associated with at least one link binary and, if the value of the link binary corresponds to the detection of at least one group of link keywords, with at least one second group of command keywords, the step of using the artificial neural network trained making it possible to further obtain a prediction of link binary and at least one prediction of second group of command keywords.

Thus, the performance of the artificial neural network for the recognition of command keywords is increased in the case where the sound signal analysed has at least a first group of command keywords and a second group of command keywords, since the range of the sound signal analysed comprising the first group of command keywords is delimited by the group of activation keywords on the one hand and the group of link keywords on the other hand.

According to an alternative embodiment compatible with the preceding alternative embodiments, at least one noiseless sound signal recorded during the step of constituting the training database is spoken by a moving speaker.

Thus, the artificial neural network has better performance for the recognition of command keywords on sound signals spoken by movable speakers, without having to multiply the number of microphones required, by means of data spatialization.

According to an alternative embodiment compatible with the preceding alternative embodiments, the training database is updated on request, at regular intervals, or automatically after detection of a change in the sound environment of the microphone.

Thus, the training database is updated to adapt to the noise in the proximity of the microphone, which may vary.

According to a sub-alternative embodiment of the preceding alternative embodiment, the step of supervised training of the artificial neural network is carried out as soon as the training database is updated.

A second aspect of the invention relates to a system for implementing the method according to the invention comprising:
at least one microphone configured to record noisy or noiseless sound signals, and the environmental noise;
at least one local calculator configured to:
   calculate sound signatures from noisy sound signals obtained via at least one microphone;
   using the artificial neural network trained on sound signatures calculated;
at least one main calculator configured to:
   constitute the training database from sound signatures calculated by the local calculator;
   train in a supervised manner the artificial neural network on the training database constituted.

According to an alternative embodiment, the system according to the invention further comprises at least one storage device configured to store each noiseless sound signal recorded.

Thus, the method according to the invention can be carried out off-line, that is, locally.

According to an alternative embodiment compatible with the preceding alternative embodiment, the system according to the invention comprises a plurality of independent or coupled microphones.

Thus, the quality of the sound signals recorded is better, in particular errors due to echoes are reduced.

According to an alternative embodiment compatible with the preceding alternative embodiments, the system according to the invention comprises one local calculator per microphone.

Thus, the central calculator trains the artificial neural network, which requires significant computational resources, and communicates the artificial neural network trained to each local calculator, which processes the sound signals recorded by the corresponding microphone.

According to an alternative embodiment compatible with the preceding alternative embodiments, the local calculator and the central calculator correspond to a single calculator.

A third aspect of the invention relates to a computer program product comprising instructions which, when the program is executed on a computer, cause the same to implement the steps of the method according to the invention.

A fourth aspect of the invention relates to a computer-readable recording medium comprising instructions which, when executed by a computer, cause the same to implement the steps of the method according to the invention.

The invention and its various applications will be better understood upon reading the following description and upon examining the accompanying figures.

### BRIEF DESCRIPTION OF THE FIGURES

The figures are set forth by way of indicating and in no way limiting purposes of the invention.

FIG. 1 is a block diagram illustrating the sequence of steps in a method according to the invention.

FIG. 2 shows a schematic representation of a first embodiment of a system according to the invention.

FIG. 3 shows a schematic representation of a second embodiment of the system according to the invention.

FIG. 4 shows a schematic representation of a third embodiment of the system according to the invention.

### DETAILED DESCRIPTION

Unless otherwise specified, a same element appearing in different figures has a single reference.

A first aspect of the invention relates to a method for analysing a sound signal which makes it possible both to recognise each group of command keywords present in the sound signal analysed and to identify the speaker of the sound signal analysed.

The sound signal analysed is recorded by at least one microphone and is noisy, that is, it comprises a useful noiseless sound signal spoken by the speaker and noise generated by the speaker's sound environment, otherwise known as environmental noise, for example a signal generated by a television set or a hoover. The environmental noise is continuously changing and can be both stationary, for example generated by a fan, and instationary, for example generated by a computer keyboard.

The invention has been tested by considering sound files corresponding to the following environments: vehicle interior, traffic noise, hoover, drill, keyboard, musical instruments, singing, white noise, etc.

By “noiseless sound signal”, it is meant a sound signal whose signal-to-noise ratio is strictly greater than 15 dB.

By “noisy sound signal”, it is meant a sound signal whose signal-to-noise ratio is less than 15 dB.

In the remainder of the description, “microphone” refers to both a single microphone and a microphone array comprising a plurality of microphones located in a same place and intended to improve the quality of recorded sound signals.

By “group of keywords”, it is meant an “intent sentence”.

Within the context of the invention, the group of keywords need not have any meaning, nor be in an existing language.

By “group of command keywords”, it is meant a group of words making it possible to trigger a command of a connected electronic device.

For example, the group of command keywords “turn down the sound” makes it possible to trigger a command for a connected loudspeaker playing music so that the loudspeaker turns down the volume, and the group of command keywords “turn off the light” makes it possible to trigger a command for a connected lamp lighting a room so that the lamp turns off.

A group of command keywords comprises at least one word.

The number of commands that can be triggered is limited and depends in particular on the number of electronic devices connected.

The commands that can be triggered are chosen by a user.

Each command is associated with at least one group of command keywords making it possible to trigger the command. For example, the command to turn off an air conditioner may be associated with both the group of command keywords “switch off the air conditioning” and the group of command keywords “turn off the air conditioner”.

The speaker of the sound signal analysed is identified from a group of speakers comprising a finite number of speakers.

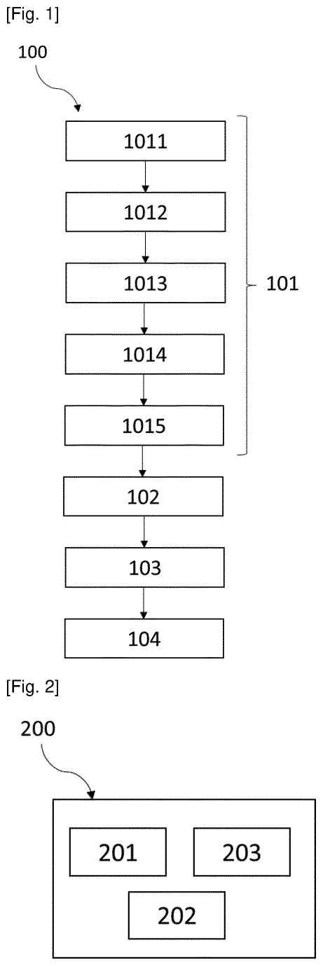

FIG. 1 is a block diagram illustrating the sequence of steps of the method 100 according to the invention.

A first step 101 of the method 100 according to the invention consists in constituting a training database.

The first step 101 includes a first sub-step 1011 consisting, for each speaker of the group of speakers, in recording at least one noiseless sound signal spoken by the speaker.

For example, on average 20 seconds of noiseless sound signals are recorded for each speaker in the group of speakers.

Each noiseless sound signal may be recorded by the microphone that recorded the noisy sound signal analysed or by another microphone.

Each noiseless sound signal is, for example, spoken by the speaker while moving, that is, the noiseless sound signal is spoken at different distinct positions.

A second sub-step 1012 consists in the microphone that recorded the noisy sound signal analysed, recording the environmental noise.

A third sub-step 1013 consists in adding the noise recorded in the second sub-step 1012 to each noiseless sound signal recorded in the first sub-step 101 to obtain a noisy sound signal.

A fourth sub-step 1014 consists in calculating a sound signature for each noisy sound signal obtained in the third sub-step 1013.

A fifth sub-step 1015 consists, for each sound signature calculated in the fourth sub-step 1014, in associating the sound signature calculated:
with the speaker who spoke the noiseless sound signal on the basis of which the sound signature has been calculated;
with at least one group of command keywords present in the noiseless sound signal.

The information associated with each noiseless sound signal in the fifth sub-step 1015 is, for example, provided by the speaker during a configuration phase.

The training database constituted then comprises each sound signature calculated in the fourth sub-step 1014 associated with the speaker and the group of command keywords associated with the sound signature in the fifth sub-step 1015.

The training database constituted in the first step 101 may be updated on request, at regular intervals, or automatically after detection of a modification of the sound environment of the microphone.

To detect a change in the sound environment of the microphone, the microphone records the environmental noise continuously, on request or at regular intervals, for example, and, for example, it is considered that there is a change in the sound environment of the microphone if a difference of at least 3 dB is observed between two recordings of the environmental noise by the microphone.

For example, there is a change in the sound environment of the microphone when a sound source appears in the proximity of the microphone, for example by a television or hoover being turned on.

A second step 102 of the method 100 according to the invention consists in training in supervised manner an artificial neural network on the training database constituted in the first step 101.

The artificial neural network may be any artificial neural network capable of carrying out multi-label classification.

Supervised training, otherwise known as supervised learning, makes it possible to train an artificial neural network for a predefined task, by updating its parameters so as to minimise a cost function corresponding to the error between the piece of output data provided by the artificial neural network and the piece of true output data, that is, what the artificial neural network should output in order to fulfil the predefined task on the basis of a certain piece of input data.

A training database therefore includes input data, each associated with a piece of true output data.

The training database comprises a plurality of sound signatures, each sound signature of the plurality of sound signatures being obtained from a noisy sound signal and associated with:
a speaker of the noisy sound signal corresponding to the sound signature;
at least one group of command keywords identified in the noisy sound signal corresponding to the sound signature.

Thus, the input data are the sound signatures and the true output data are the speaker and the group or groups of command keywords.

The supervised training of the artificial neural network therefore consists in updating the parameters so as to minimise a cost function which takes account of the error between the prediction of speaker provided by the artificial neural network from a sound signature in the training database and the speaker associated with the sound signature in the training database, and the error between the prediction of command keyword group provided by the artificial neural network from the sound signature and the group of command keywords associated with the sound signature in the training database.

The cost function is, for example, the binary cross-entropy function.

All sound signatures in the training database are of the same type.

Each sound signature of the training database is for example of the type Mel frequency cepstral coefficients of the corresponding noisy sound signal, of the type i-vector obtained from the corresponding noisy sound signal or of the type x-vector obtained from the corresponding noisy sound signal.

The second step 102 is carried out, for example, as soon as the training database is updated.

A third step 103 of the method 100 according to the invention consists in calculating a sound signature from the sound signal analysed.

The sound signature calculated in the third step 103 is of the same type as the sound signatures in the training database.

A fourth step 104 of the method 100 according to the invention consists in using the artificial neural network trained in the second step 102 on the sound signature calculated in the third step 103.

The artificial neural network then provides a prediction of speaker and at least one prediction of command keyword group.

The prediction of speaker corresponds to a speaker from the group of speakers or to a parameter indicating that the speaker is not known.

The prediction of command keyword group corresponds to a group of command keywords encountered during the supervised training or to a parameter indicating that the group of command keywords is unknown or non-existent.

The artificial neural network therefore carries out a multi-label classification giving the identity of the speaker or detecting an unknown speaker via a first group of labels and giving the group of command keywords possibly detected for the speaker detected via a second group of labels.

In addition to the groups of command keywords, the sound signal analysed may also comprise a group of activation keywords preceding the group or groups of command keywords.

A group of activation keywords comprises at least one word.

A group of activation keywords is, for example, “hello” or “please”.

In the case where the sound signal analysed comprises a group of activation keywords, a sound signal making it possible to trigger a command resulting in an air conditioner being switched off therefore includes, for example, the useful sound signal “hello switch off the air conditioning”, “hello” being the group of activation keywords and “switch off the air conditioning” being the group of command keywords.

In this case, each sound signature in the training database is also associated with an activation binary relating to the detection or non-detection of at least one group of activation keywords in the noisy sound signal corresponding to the sound signature, that is, being 1 if at least one group of activation keywords is present and 0 otherwise, and the artificial neural network also provides a prediction of activation binary in the fourth step 104.

As an alternative to the use of a group of activation keywords, before recording a sound signal, the speaker has, for example, to wait for a certain time, for example in the order of one second, before speaking the group or groups of command keywords.

In addition to the groups of activation and command keywords, the sound signal analysed may also comprise a group of termination keywords following the group or groups of command keywords.

A group of termination keywords comprises at least one word.

A group of termination keywords is, for example, “end” or “thank you”.

In the case where the sound signal analysed comprises a group of termination keywords, a sound signal making it possible to trigger a command resulting in an air conditioner being switched off therefore includes, for example, “hello switch off the air conditioning thank you”, “hello” being the group of activation keywords, “switch off the air conditioning” being the group of command keywords and “thank you” being the group of termination keywords.

In this case, each sound signature in the training database is also associated with a termination binary relating to the detection or non-detection of at least one group of termination keywords in the noisy sound signal corresponding to the sound signature, and the artificial neural network also provides, in the fourth step 104, a prediction of termination binary.

The sound signal analysed may also include a group of link keywords located between two groups of command keywords.

A group of link keywords comprises at least one word.

A group of link keywords is for example “and” or “then”.

In the case where the sound signal analysed includes a group of link keywords, a sound signal making it possible to trigger a command resulting in an air conditioner being switched off and the light being turned off therefore includes, for example, the useful sound signal “hello switch off the air conditioning then turn off the light”, “hello” being the group of activation keywords, “switch off the air conditioning” being the first group of command keywords, “then” being the group of link keywords, and “turn off the light” being the second group of command keywords.

In this case, each sound signature in the training database is also associated with at least one link binary relating to the detection or non-detection of at least one group of link keywords in the noisy sound signal corresponding to the sound signature, and with at least one second group of command keywords if the value of the link binary corresponds to the detection of at least one group of link keywords, and the artificial neural network also provides, in the fourth step 104, a prediction of link binary and a prediction of second group of command keywords.

Using the method 100 according to the invention on a 5-second noisy sound signal with a signal-to-noise ratio equal to 20 for a set of 20 groups of command keywords, it is obtained:
an Equal Error Rate of 6% for the prediction of speaker;
a Mean Absolute Error of 7% for the prediction of command keyword groups.

If the training database includes sound signatures obtained from noisy sound signals spoken by moving speakers, a Mean Absolute Error of 9% is obtained for the prediction of command keyword groups.

A second aspect of the invention relates to a system 200 for implementing the method 100 according to the invention.

FIG. 2 shows a schematic representation of a first embodiment of the system 200 according to the invention.

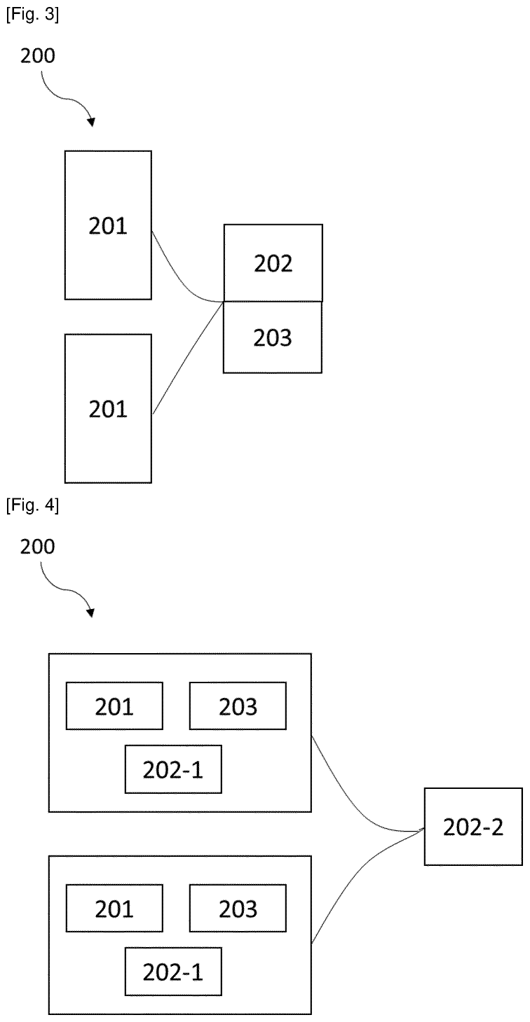

FIG. 3 shows a schematic representation of a second embodiment of the system 200 according to the invention.

FIG. 4 shows a schematic representation of a third embodiment of the system 200 according to the invention.

Regardless of the embodiment, the system 200 according to the invention comprises:
at least one microphone 201 configured to record noisy sound signals, noiseless sound signals and environmental noise;
at least one local calculator 202-1 configured to:
   calculate sound signatures from noisy sound signals obtained via at least one microphone 201;
   use the artificial neural network trained on sound signatures calculated;
at least one central calculator 202-2 configured to:
   constitute the training database from sound signatures calculated;
   train in a supervised manner the artificial neural network on the training database constituted; the local calculator 202-1 possibly being the same as the central calculator 202-2.

The system 200 according to the invention includes, for example, a plurality of independent or coupled microphones 201.

The system 200 according to the invention comprises, for example, four microphones 201, which makes it possible to cover 360°.

The system 200 according to the first embodiment comprises at least one microphone 201 physically connected to a single calculator 202 acting both as local calculator 202-1 and as central calculator 202-2.

In FIG. 2, the system 200 includes a single microphone 201 physically connected to a calculator 202.

The system 200 according to the second embodiment includes at least one microphone 201 connected via a wired or wireless link to a single calculator 200 acting both as local calculator 202-1 and as central calculator 202-2.

In FIG. 3, the system 200 includes two microphones 201 connected via a wireless link to a calculator 202.

The system 200 according to the third embodiment includes at least one microphone 201, each microphone 201 being connected physically or via a wired or wireless link to a local calculator 202-1 and each local calculator 202-1 being connected via a wired or wireless link to a central calculator 202-2.

In FIG. 4, the system 200 includes two microphones 201 each physically connected to a local calculator 202-1 and each local calculator 202-1 being connected via a wireless link to a central calculator 202-2.

The system 200 according to the invention may also include a storage device 203, for example a memory.

The storage device 203 stores, for example, each noiseless sound signal recorded during the first sub-step 1011 or each noiseless sound signal recorded during the first sub-step 1011 by a given microphone 201.

The system 200 according to the invention is for example a communication gateway and more particularly a connected loudspeaker.

In order to highlight the performance of the approach provided in the invention, a comparison is provided, in Table 1 below, with three marketed tools from the state of the art.

This comparative study highlights the speed of implementation of the approach according to the invention, with learning and inference times well below those provided by other solutions in the state of the art, while requiring a very small memory space for storing the model. This is advantageously possible by means of the local execution, and not on a cloud for the learning and inference of the model, and by the use of a small learning database (less than 10 MB), unlike other solutions whose database exceeds 100 GB.

Furthermore, the performance of the provided approach, measured by the command acceptance rate, is as good as or better than other tools.

Finally, from an application point of view, the provided approach is more generic than commercially available tools. In particular, the provided approach enables noise or speech detection (VAD), command detection (CMD), sound environment identification (ASC) and speaker identification (SPEAKER ID); whereas the provided commercial solutions only enable noise or speech detection (VAD) and command detection (CMD) or speaker identification (SPEAKER ID).

TABLE 1

| | Invention | Tool 1 | Tool 2 | Tool 3 |
|---|---|---|---|---|
| Model size (MB) | 0.5 | 3 | >100 | 40 |
| Inference | 15 | 60 | >500 | 350 |
| time (ms) | | | | |
| Learning time | <1 s | >1 h | >1 h | >1 min |
| | | (cloud) | (cloud) | (cloud) |
| Command | 95 | 97 | 80 | 85 |
| acceptance | | | | |
| rate (%) | | | | |
| Application | VAD | VAD | VAD | SPEAKER |
| | SPEAKER ID | CMD | CMD | ID |
| | CMD | | | |
| | ASC | | | |
| Size of | 6 MB | >100 GB | >100 GB | >100 GB |
| learning | | | | |
| database | | | | |

This comparative study has evaluated the performance of the invention in various contexts. Three of these are summarised in Table 2, below, and highlight the efficiency and speed of the provided approach for the recognition of speaker and keywords. The table contains metrics for evaluating the method according to the invention after 20 seconds of learning the speaker's voice and 12 emissions of command words in different sound environments.

The provided approach therefore adapts efficiently and rapidly to the conditions of use in which it is implemented. In particular, for detrimental signal-to-noise ratios (SNR), with high noise levels, the approach guarantees the robustness of recognition of the speaker (“voice” columns) and recognition of command words (“command” columns). It can be observed that the learning time of the model is systematically less than 1 s to achieve a high success rate, whereas with known tools of the state of the art this time is greater than 1 h.

It is also noted that the provided approach requires a small amount of memory compared to known methods of the state of the art, which generally require more than 1 GB of RAM for training the model and disk space to store the learning database.

TABLE 2

| | RSB = 20 | | RSB = 10 | | RSB = 0 | |
|---|---|---|---|---|---|---|
| | Voice | Command | Voice | Command | Voice | Command |
| Success | 93 | 97 | 98 | 96 | 95 | 85 |
| rate (%) | | | | | | |
| Learning | 45 | 210 | 45 | 210 | 45 | 210 |
| time (ms) | | | | | | |
| Inference | 1.1 | 2.5 | 1.1 | 2.5 | 1.1 | 2.5 |
| time (ms) | | | | | | |
| Memory | 160 | 450 | 160 | 450 | 160 | 450 |
| (kB) | | | | | | |

| | |
|---|---|
| database | 6 |
| (MB) | |

1. A method for analysing a noisy sound signal for the recognition of at least one group of command keywords and a speaker of the noisy sound signal analysed, the noisy sound signal to be analysed being recorded by at least one microphone and the method comprising:
constituting a training database comprising the following sub-steps of:
for each speaker to be recognised, recording at least one noiseless sound signal spoken by the speaker;
recording, by the microphone, the environmental noise, the environmental noise being a noise generated by the speaker's sound environment;
for each noiseless sound signal recorded, adding the noise recorded to the noiseless sound signal to obtain a noisy sound signal;
for each noisy sound signal obtained, calculating a sound signature of the noisy sound signal obtained;
for each sound signature calculated, associating the sound signature calculated with the speaker who spoke the corresponding noiseless sound signal and with at least one group of command keywords;
supervised training of an artificial neural network on the training database constituted to obtain an artificial neural network trained capable of providing, from a sound signature obtained from a noisy sound signal, a prediction of speaker and at least one prediction of command keyword group;
calculating a sound signature of the noisy sound signal analysed;
using the artificial neural network trained on the sound signature calculated to obtain a prediction of speaker and at least one prediction of command keyword group.

2. The method according to claim 1, wherein the artificial neural network trained is further capable of providing, from a sound signature, a prediction of activation binary relating to the detection or non-detection of at least one group of activation keywords, each sound signature of the training database being further associated with an activation binary, the using of the artificial neural network trained making it possible to further obtain a prediction of activation binary.

3. The method according to claim 1, wherein the artificial neural network trained is further capable of providing, from a sound signature, a prediction of termination binary relating to the detection or non-detection of at least one group of termination keywords, each sound signature of the training database being further associated with a termination binary, the using of the artificial neural network trained making it possible to further obtain a prediction of termination binary.

4. The method according to claim 1, wherein the artificial neural network trained is further capable of providing, from a sound signature, at least one prediction of link binary relating to the detection or non-detection of at least one group of link keywords, each sound signature of the training database being further associated with at least one link binary and, if the value of the link binary corresponds to the detection of at least one group of link keywords, with at least one second group of command keywords, the using of the artificial neural network trained making it possible to further obtain a prediction of link binary and at least one prediction of second group of command keywords.

5. The method according to claim 1, wherein at least one noiseless sound signal recorded during the constituting of the training database is spoken by a moving speaker.

6. The method according to claim 1, wherein the training database is updated on request, at regular intervals, or automatically after detection of a change in the sound environment of the microphone.

7. The method according to claim 6, wherein the supervised training of the artificial neural network is carried out as soon as the training database is updated.

8. A system for implementing the method according to claim 1, comprising:
at least one microphone configured to record noisy or noiseless sound signals and the environmental noise;
at least one local calculator configured to:
calculate sound signatures from noisy sound signals obtained via at least one microphone;
use the artificial neural network trained on sound signatures calculated;
at least one main calculator configured to:
constitute the training database from sound signatures calculated by the local calculator;
train in a supervised manner the artificial neural network on the training database constituted.

9. The system according to claim 8, further comprising at least one storage device configured to store each noiseless sound signal recorded.

10. The system according to claim 8, comprising a plurality of independent or coupled microphones.

11. The system according to claim 8, comprising one local calculator per microphone.

12. The system according to claim 8, wherein the local calculator and the central calculator correspond to a single calculator.

13. A computer program product comprising instructions which, when the program is executed on a computer, cause the same to implement the steps of the method according to claim 1.

14. A non-transitory computer-readable storage medium comprising instructions which, when executed by a computer, cause the same to implement the method according to claim 1.
